(19) United States
(12) Patent Application Publication
(10) Pub. No.: US 2005/0142473 A1
(43) Pub. Date: Jun. 30, 2005

(54) Compliant photoconductive image-forming sleeve member and process for making same

(76) Inventors: Michel F. Molaire, Rochester, NY (US); Wayne T. Ferrar, Fairport, NY (US)

Correspondence Address: Mark G. Bocchetti;Patent Legal Staff, Eastman Kodak Company, 343 State Street, Rochester, NY, 14650-2201, US

(21) Appl. No.: 11/020,505

(22) Filed: Dec. 21, 2004

Related U.S. Application Data
(60) Provisional application No. 60/532,711, filed on Dec. 24, 2003.

(51) Int. Cl. G03G 5/14

(52) U.S. Cl. 430/64; 430/60; 430/131

(57) ABSTRACT

A photoconductive primary image-forming sleeve member for use in an electrophotographic apparatus includes: a cylindrical conductive substrate, a compliant layer formed on the substrate, an electrically conducting protective layer including dispersed tin oxide particles formed on the compliant layer, a barrier layer formed on the protective layer, a charge-generating layer formed on the barrier layer, and a charge-transport layer formed on the charge-generating layer.

### FIELD OF THE INVENTION

The present invention relates to electrophotographic apparatus and, more particularly, to a primary image-forming sleeve member that includes a compliant layer.

### BACKGROUND OF THE INVENTION

The use of an intermediate transfer member in an electrostatographic machine to transfer toner from an imaging member to a receiver, e.g., paper, is well known, and is practiced in commercial electrophotographic copiers and printers. A toner image formed on a primary image-forming member (PIFM) is transferred in a first transfer operation to an intermediate transfer member, and is subsequently transferred in a second transfer operation from the intermediate transfer member to a receiver. In the second transfer of a toner image from an intermediate transfer member roller to a receiver, a transfer back-up roller is commonly used behind a paper receiver, a nip being formed to press the receiver to the intermediate transfer member.

U.S. Pat. Nos. 5,715,505 and 5,828,931, the disclosures of which are incorporated herein by reference, describe a primary image-forming member (PIFM) such as a roller that includes a thick compliant blanket layer coated on a core member and surrounded by a relatively thin concentric photoconductive layer. The compliant PIFM roller provides improved electrostatic transfer of a toner image to a receiver member.

U.S. Pat. No. 6,541,171, the disclosure of which is incorporated herein by reference, describes a single-sleeved compliant PIFM roller and a method for making it. The photoconductive sleeve, which is flexible, replaceable, and removable, and is formed on a substrate that is in non-adhesive contact with a compliant layer coated on a core member, represents an improvement over the photoconductive layers described in U.S. Pat. Nos. 5,715,505 and 5,828,931: a photoconductive sleeve coating can be made reliably and cheaply, and it can be readily removed and replaced when at the end of its useful life, thereby lowering cost and reducing downtime of the apparatus.

U.S. Pat. No. 5,732,311, the disclosure of which is incorporated herein by reference, describes an electrographic PIFM member such as a roller that includes a support member, a charge retention layer for the electrographic image, and an intermediate compliant layer between the charge retention and the support layers.

U.S. Pat. No. 6,541,171 discloses a photoconductive structure coated on a sleeve substrate that is subsequently mounted on a compliant coating formed on a core member. Because the sleeve substrate is disposed between the compliant layer coated on the core substrate and the photoconductive layer, the effectiveness of the compliant layer is diminished.

To optimize the effectiveness of the compliant layer, it would be desirable to construct a photoconductor having a structure similar to that of the electroreceptor of U.S. Pat. No. 5,732,311, that is, having the photoconductive layer disposed in close proximity to a compliant layer coated on a substrate. A major concern in fabricating such a photoconductor is the likelihood of seriously damaging the compliant layer in the course of coating the overlying photoconductive structure. This difficulty is overcome by the tin oxide-containing protective layer included in the primary image-forming sleeve member of the present invention.

### SUMMARY OF THE INVENTION

The present invention is directed to a compliant photoconductive primary image-forming sleeve member that is intended for use in an electrophotographic apparatus and includes: a cylindrical conductive substrate, a compliant layer formed on the substrate, an electrically conducting protective layer comprising dispersed tin oxide particles formed on the compliant layer, a barrier layer formed on the protective layer, a charge-generating layer, formed on the barrier layer, and a charge-transport layer formed on the charge-generating layer.

The present invention is further directed to a process for forming a compliant photoconductive primary image-forming sleeve member that includes an electrically conducting protective layer comprising dispersed tin oxide particles.

### BRIEF DESCRIPTION OF THE DRAWINGS

FIG. 1 is a schematic cross-sectional view, not to scale, of a compliant photoconductive primary image-forming sleeve member of the present invention; and

FIG. 2 is a graph showing the change in surface potential as a function of exposure for a compliant photoconductive primary image-forming sleeve member of the invention.

### DETAILED DESCRIPTION OF THE INVENTION

The present inventors have discovered that a coating of an aqueous dispersion of sub-micron tin oxide particles in a suitable binder provides an electrically conductive layer that is also an effective protective layer for preventing attack of an underlying compliant layer by solvents used in the subsequent coating of barrier, charge-generating, and charge-transport layers.

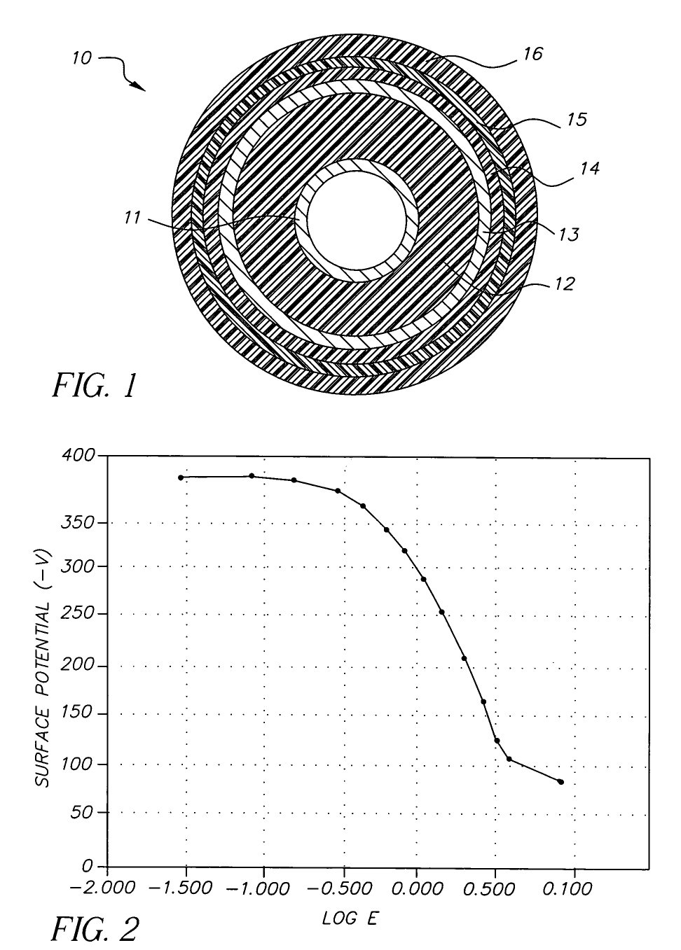

As schematically depicted in FIG. 1, a compliant photoconductive primary image-forming sleeve member 10 of the present invention includes a cylindrical conductive core substrate 11, a compliant layer 12 formed on substrate 11, an electrically conducting protective layer 13 having dispersed tin oxide particles formed on compliant layer 12, a barrier layer 14 formed on protective layer 13, a charge-generating layer 15 formed on barrier layer 14, and a charge-transport layer 16 formed on charge-generating layer.

Cylindrical conductive substrate 11 can be formed from a metal or a plastic. Suitable metals include nickel, aluminum, or steel. Preferably, conductive substrate 11 includes a tubular nickel belt having a thickness of, preferably, about 5 mils. Compliant layer 12 preferably is a polyurethane having a Young's modulus of, preferably, between 10⁶ and 10⁷ Pascals, as described in U.S. Pat. No. 5,715,505, and has a thickness of, preferably, about 0.5 mm to about 20 mm.

Electrically conducting protective layer 13 include tin oxide particles in an amount of, preferably, about 50 wt. % to about 90 wt. %, more preferably, about 70 wt. % to about 80 wt. %, dispersed in a polymeric binder such as, for example, 2-hydroxyethyl cellulose. The thickness of layer 13 is preferably about 0.5 μm to about 10 μm, more preferably, about 1 μm to about 5 μm.

Barrier layer 14, which preferably includes a polyamide resin such as AMILAN™ CM8000 polyamide, has a thickness of, preferably, about 0.5 μm to about 3.0 μm.

Charge-generating layer 15, which is coated on barrier layer 14, can be prepared from any suitable materials well known in the literature but preferably includes a titanyl phthalocyanine/titanyl fluorophthalocyanine co-crystalline dispersion, as described in U.S. Pat. No. 5,614,342. Charge-generating layer 15 has a thickness of, preferably, about 0.5 μm to about 1.0 μm.

Charge-transport layer 16 can include any suitable compositions and materials well known in the published literature but preferably includes equal parts of tri-tolylamine and 1,1-bis {4-(di-4-tolylamino)phenyl} methane in a binder consisting of 20% wt/wt poly[4,4′-(2-norbomylidene)bisphenol terephthalate-co-azelate-(60/40)] and 80% wt/wt MAKROLON™, a polycarbonate obtainable from General Electric Company, Schenectady, N.Y. Charge-transport layer 16, which has a thickness preferably of about 10 μm to about 40 μm, more preferably, about 25 μm, can optionally be overcoated with a thin, hard, wear-resistant layer (not shown).

The photoconductive primary image-forming member illustrated in the previously discussed U.S. Pat. No. 6,541,171 provides a cylindrical central member that includes a core substrate and a compliant layer, together with a removable sleeve that includes a stiffening layer as a sleeve substrate, on which are formed charge-generating and charge-transport layers. By contrast, as shown in FIG. 1, the photoconductive primary image-forming sleeve member of the present invention includes only a single substrate; there is no intervening second substrate to diminish the effectiveness of the compliant layer underlying the photoconductive layers. Furthermore, as already noted, the coating of dispersed tin oxide particles is effective for preventing attack of the underlying compliant layer by solvents used in the subsequent coating of barrier, charge-generating, and charge-transport layers.

A photoconductive primary image-forming member of the present invention is prepared according to the following illustrative procedure:

A glass container provided with a stirrer is charged with 3440 grams of deionized water and 160 grams of 2-hydroxyethyl cellulose from Aldrich Chemicals (MW ca 90,000). To the resulting solution is added, with constant stirring, 1500 grams of SN-100D, a 30 wt. % water dispersion of ultrafine electroconductive tin oxide, available from Ishihara Sangyo Kaissha Ltd. of Japan. The final dispersion contains 12 wt. % solids, 73.8 wt. % of which is tin oxide.

A NEXPRESS™ 2100 blanket sleeve cylinder consisting of a 5-mil thick nickel sleeve substrate (comprising core member 11) coated with a polyurethane compliant layer is dip coated in the electro-conductive tin oxide dispersion at a withdrawal rate of 0.20 inch/sec (no overflow). The coated sleeve is dried in a Blue M oven at a temperature of 110° C. for 30 minutes, cooled to room temperature, dip coated at 0.20 inch/sec in an ethanol/dichloromethane solution containing 5 wt. % AMILAN™ CM8000 polyamide (available from Bray Chemical Inc. of Japan) to provide a barrier layer, and again dried at 110° C. for 30 minutes.

The barrier layer-coated sleeve is then dip coated at 0.15 inch/sec in an IR-sensitive pigment dispersion containing a 90/10 (wt./wt.) titanyl phthalocyanine/fluorinated titanyl phthalocyanine cocrystalline pigment mixture and 50 wt. % of a polyesterionomer in a dichloromethane/1,1,2 trichloroethane solvent mixture, as described in U.S. Pat. No. 5,614,342. The coated sleeve is dried at 110° C. for 30 minutes, then coated, as described in U.S. Pat. No. 5,614,342, with a charge-transport layer solution (14 wt. % solids in dichloromethane as solvent) containing the following solids: 2 parts by weight of tri-tolylamine, 2 parts by weight of 1,1-bis(4-di-p-tolylaminophenyl) methane, 1 part by weight of poly[4,4′-(2-norbomylidene)bisphenol terephthalate-co-azelate(60/40), and 5 parts by weight of MAKROLON™ polycarbonate, obtainable from the General Electric Company of Schenectady, N.Y. The fully coated belt is again dried at 110° C. for 30 minutes. Upon cooling, a completed photoconductive sleeve member in the form of the fully coated nickel belt is freed from the coating mandrel.

The fully coated compliant photoconductive sleeve member is then placed in a PDT-1000 sensitometer sold by the QEA Corporation and tested for photoconductivity. The graph in FIG. 2 shows the change in surface potential as a function of exposure from an initial value of −400 volts.

The invention has been described in detail with particular reference to preferred embodiments thereof, but it will be understood that variations and modifications can be effected within the spirit and scope of the invention, which is defined by the claims that follow.

1. A compliant photoconductive primary image-forming sleeve member for use in an electrophotographic apparatus, said member comprising:
a cylindrical conductive substrate;
a compliant layer formed on said substrate;
an electrically conducting protective layer including dispersed tin oxide particles formed on said compliant layer;
a barrier layer formed on said protective layer;
a charge-generating layer formed on said barrier layer, and
a charge-transport layer formed on said charge-generating layer.

2. The primary image-forming sleeve member of claim 1 wherein said cylindrical conductive substrate is formed from a metal or a plastic.

3. The primary image-forming sleeve member of claim 2 wherein said cylindrical conductive substrate is formed from a metal selected from the group consisting of nickel, aluminum, and steel.

4. The primary image-forming sleeve member of claim 3 wherein said cylindrical conductive substrate comprises a tubular nickel belt.

5. The primary image-forming sleeve member of claim 4 wherein said nickel belt has a thickness of about 5 mils.

6. The primary image-forming sleeve member of claim 1 wherein said compliant layer formed on said substrate comprises a polyurethane.

7. The primary image-forming sleeve member of claim 1 wherein said compliant layer has a thickness of about 0.5 mm to about 20 mm.

8. The primary image-forming sleeve member of claim 1 wherein said electrically conducting protective layer further comprises a polymeric binder.

9. The primary image-forming sleeve member of claim 8 wherein said polymeric binder comprises 2-hydroxyethyl cellulose.

10. The primary image-forming sleeve member of claim 1 wherein said electrically conducting protective layer comprises said tin oxide particles in an amount of about 50 wt. % to about 90 wt. %.

11. The primary image-forming sleeve member of claim 10 wherein said electrically conducting protective layer comprises said tin oxide particles in an amount of about 70 wt. % to about 80 wt. %.

12. The primary image-forming sleeve member of claim 1 wherein said electrically conducting protective layer has a thickness of about 0.5 μm to about 10 μm.

13. The primary image-forming sleeve member of claim 12 wherein said electrically conducting protective layer has a thickness of about 1 μm to about 5 μm.

14. The primary image-forming sleeve member of claim 1 wherein said barrier layer comprises a polyamide resin.

15. The primary image-forming sleeve member of claim 1 wherein said barrier layer has a thickness of about 0.5 μm to about 1.0 μm.

16. The primary image-forming sleeve member of claim 1 wherein said charge-generating layer comprises a titanyl phthalocyanine/titanyl fluorophthalocyanine co-crystal dispersion.

17. The primary image-forming sleeve member of claim 1 wherein said charge-generating layer has a thickness of about 0.5 μm to about 1.0 μm.

18. The primary image-forming sleeve member of claim 1 wherein said charge-transport layer comprises tri-tolylamine, 1,1-bis(4-di-p-tolylaminophenyl) methane, and a polycarbonate.

19. The primary image-forming sleeve member of claim 1 wherein said charge-transport layer has a thickness of about 10 μm to about 40 μm.

20. A process for forming a compliant photoconductive primary image-forming sleeve member for use in an electrophotographic apparatus, said process comprising:
forming a compliant layer on a cylindrical conductive substrate;
forming an electrically conducting protective layer including dispersed tin oxide particles on said compliant layer;
forming a barrier layer on said electrically conducting protective layer;
forming a charge-generating layer on said barrier layer; and
forming a charge-transport layer coated on said charge-generating layer.

21. The process of claim 20 wherein said forming said compliant layer comprises coating said cylindrical conductive substrate with a solution containing a polyurethane and an organic solvent, and removing said solvent.

22. The process of claim 20 wherein said forming said electrically conducting protective layer comprises:
preparing an aqueous dispersion including said tin oxide particles and a polymeric binder;
applying a coating of said aqueous dispersion to said compliant layer; and
drying said coating of said aqueous dispersion.

23. The process of claim 22 wherein said polymeric binder comprises 2-hydroxyethyl cellulose.

24. The process of claim 20 wherein said forming said barrier layer comprises applying to said electrically conducting protective layer a solution containing a polyamide and an organic solvent, and removing said solvent.

25. The process of claim 20 wherein said forming said charge-generating layer comprises applying to said barrier layer a mixture containing a titanyl phthalocyanine/titanyl fluorophthalocyanine co-crystalline dispersion, a polyesterionomer, and an organic solvent, and removing said solvent.

26. The process of claim 20 wherein said forming said charge-transport layer comprises applying to said charge-generating layer a mixture containing tri-tolylamine, 1,1-bis(4-di-p-tolylaminophenyl) methane, a polycarbonate, and an organic solvent, and removing said solvent.
